(19) United States
(12) Patent Application Publication
(10) Pub. No.: US 2006/0210105 A1
(43) Pub. Date: Sep. 21, 2006

(54) Combined computer mouse and speaker device

(75) Inventor: Ho-Hsin Liao, Taipei (TW)

Correspondence Address: BACON & THOMAS, PLLC, 625 SLATERS LANE, FOURTH FLOOR, ALEXANDRIA, VA, 22314, US

(73) Assignee: BENEXT INNO-PRODUCT DEVELOPMENT LTD., Taipei (TW)

(21) Appl. No.: 11/130,094

(22) Filed: May 17, 2005

(30) Foreign Application Priority Data
Mar. 16, 2005 (TW) 094108073

(51) Int. Cl. H04R 1/02; G09G 5/08; H04R 9/06

(52) U.S. Cl. 381/334; 345/163; 361/683; 381/333; 381/124; 381/386

(57) ABSTRACT

A combined computer mouse and speaker device includes two major devices: a mouse device and a speaker device. The speaker device may include one woofer/midrange and a pair of tweeters. Because the size of the woofer/midrange is relatively large, the woofer/midrange is preferably located at the rear portion of the combined computer mouse and speaker device. The pair of tweeters is preferably located on each side of the woofer/midrange.

### BACKGROUND OF THE INVENTION

1. Field of the Invention

The present invention relates to a combined computer mouse and speaker device and, more particularly, to a combined computer mouse and speaker device for a portable computer.

2. Description of the Related Art

Many portable computers (such as notebook computers or tablet computers) have one or more speakers; however, all portable computers have very strict thickness limitations, which also places limits on the design of the speaker. Usually, the speakers in a portable computer are tweeters, as woofer/midrange speakers require larger amounts of space, which is not suitable for a portable computer.

In order to improve the audio quality of a portable computer, U.S. Pat. No. 6,243,260 discloses a portable computer with rotatable speakers; another patent, U.S. Pat. No. 6,807,053, discloses a portable computer with speakers located at different positions.

Both above-mentioned improvements concern various computer housing designs, but they are unable to solve the problem related to woofers. Therefore, the user must buy additional speakers for better audio quality, and this is very inconvenient when traveling.

Therefore, it is desirable to provide a combined mouse device and speaker device to mitigate and/or obviate the aforementioned problems.

### SUMMARY OF THE INVENTION

A main objective of the present invention is to provide a speaker device for a computer, and the speaker device is combined with the mouse device.

Another objective of the present invention is to provide a portable speaker device, and, more particularly, for a portable computer. Therefore, the users only need one device for mouse device and speaker device.

In order to achieve the above-mention objectives, the combined computer mouse and speaker device includes two major devices: a mouse device device and a speaker device. The speaker device may include one woofer/midrange and a pair of tweeters. Because the size of the woofer/midrange is relatively large, the woofer/midrange is preferably located at the rear portion of the combined computer mouse and speaker device. The pair of tweeters are preferably located on each side of the woofer/midrange.

The combined computer mouse and speaker device only needs one transmission cable, which can be a typical USB transmission cable.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a combined computer mouse and speaker device according to the present invention.

FIG. 2 is a cross-sectional schematic drawing of a first embodiment of the combined computer mouse and speaker device according to the present invention.

FIG. 3 is a perspective view of a combined computer mouse and speaker device of the present invention being connected to a computer.

FIG. 4 is a perspective drawing of a second embodiment of a combined computer mouse and speaker device according to the present invention.

FIG. 5 is a perspective drawing of second embodiment of a combined computer mouse and speaker device, which shows a covering with an aperture opened.

FIG. 6 is a top view of a third embodiment of a combined computer mouse and speaker device according to the present invention.

FIG. 7 is a cross-sectional schematic drawing of a fourth embodiment of a combined computer mouse and speaker device according to the present invention.

FIG. 8 is a block diagram of a circuit structure for the first embodiment to the fourth embodiment.

FIG. 9 is a block diagram of the combined computer mouse and speaker device being connected to different connectors.

FIG. 10 is another block diagram of the combined computer mouse and speaker device being connected to different connectors.

### DETAILED DESCRIPTION OF THE PREFERRED EMBODIMENT

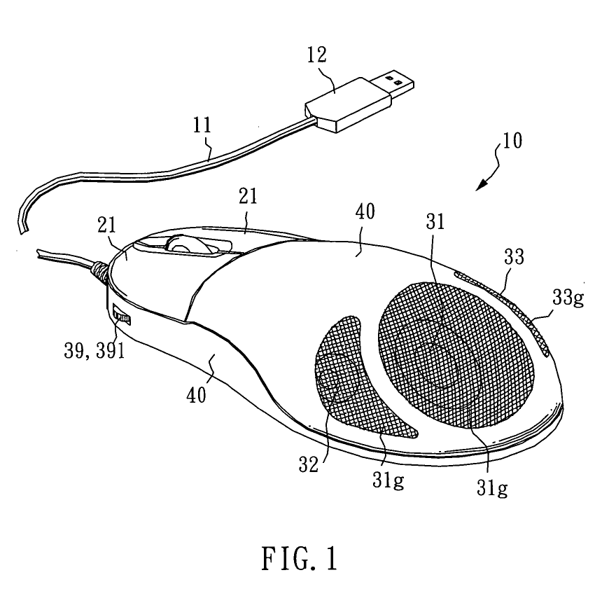

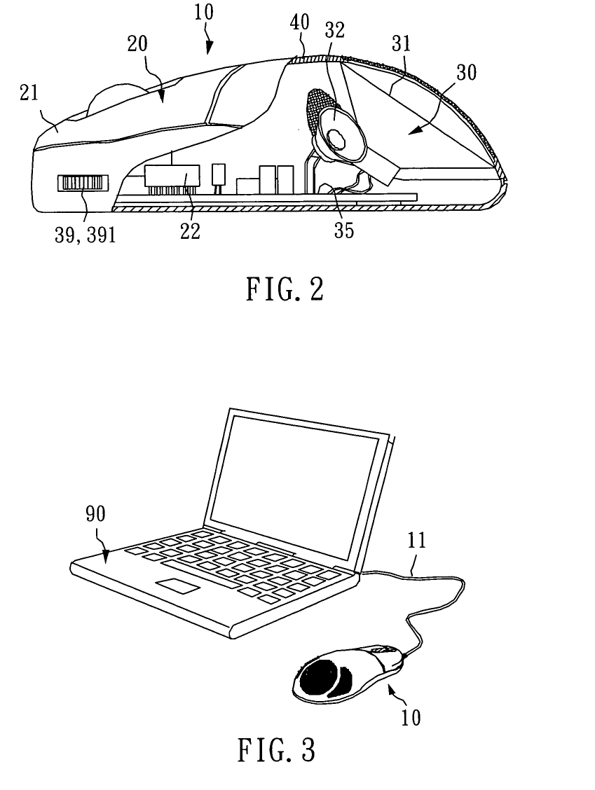

Please refer to FIG. 1 and FIG. 2 for the first embodiment of the present invention. A combined computer mouse and speaker device 10 has a shape typical of computer mice. The combined computer mouse and speaker device 10 comprises a mouse device 20 and a speaker device 30.

The mouse device 20 includes a mechanism that provides the functionality of a standard computer mouse (such as mouse buttons 21) and an electronic device 22 (which is a typical computer mouse circuit, and may include a USB control circuit to support USB transmission standards). Since the mouse device 20 is well-known technology, it requires no further description; it should be noted that the mouse device 20 may also be a roller mouse device or an optical mouse device etc.

The speaker device 30 includes a woofer/midrange speaker 31, and two tweeters 32, 33 in the first embodiment. The speaker device 30 also includes some simple circuits 35 (which can be designed to be disposed on the same circuit board as the electronic device 22), such as an amplifier or USB control circuit. Since the speaker device 30 is well-known technology, it requires no further description. However, the meaning of the woofer/midrange speaker 31 in this embodiment is defined as a speaker which is able to provide audio frequencies that are lower than the audio frequencies provided by the two tweeters 32, 33.

The mouse device 20 and the speaker device 30 are both placed in a common housing 40, which might be composed of a plurality of housings. In the first embodiment, the woofer/midrange speaker 31, and the two tweeters 32, 33, are exposed at the surface of the common housing 40. Since the speakers 31, 32, 33 are exposed, three grilles 31g, 32g, 33g may be provided to cover the speakers 31, 32, 33. The woofer/midrange speaker 31 is placed at the rear portion of the combined computer mouse and speaker device 10, since the mouse buttons 21 and the other electronic devices are place towards the front of the combined computer mouse and speaker device 10, and the woofer/midrange speaker 31 requires a larger space. The combined computer mouse and speaker device 10 has a larger space towards the back to accommodate the woofer/midrange speaker 31. The two tweeters 32, 33 should be separated from each other, such as by being placed along two sides of the woofer/midrange speaker 31 to create a stereophonic effect.

An speaker switch 39 (such as a slide or a roller) is electrically connected to the circuit 35, and the speaker switch 39 can also be a volume adjustment switch 391, so the user can adjust volume of the speaker device 30.

Please refer to FIG. 3. The combined computer mouse and speaker device 10 of the present invention is connected to a computer 90 via a transmission cable 11. In the first embodiment, the transmission cable 11 is a USB (Universal Serial Bus) connector 12. Because of the characteristics of the USB standard, the combined computer mouse and speaker device 10 requires only one transmission cable.

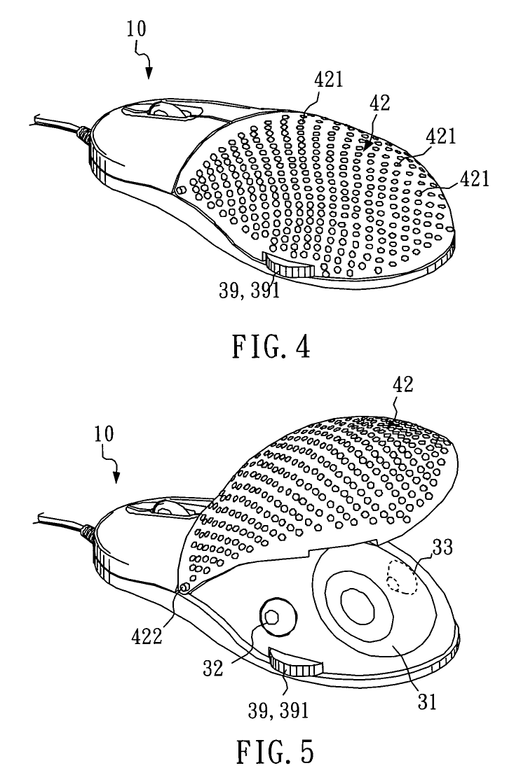

Please refer to a second embodiment of the present invention shown in FIG. 4. In order to protect or provide decoration for the speakers 31, 32, 33, a covering 42 with a plurality of apertures 421 can be placed over the speakers 31, 32, 33, so that the grilles 31g, 32g, 33g are not necessarily required.

Please refer to FIG. 5. The covering 42 further comprises a pivot mechanism 422 so that the covering 42 can be lifted and opened; when the user is not using the mouse, the speakers 31, 32, 33 can then provide a better audio experience. However, the covering 42 doesn't need to be provided a pivoting design, as the audio can still pass through the plurality of apertures 421.

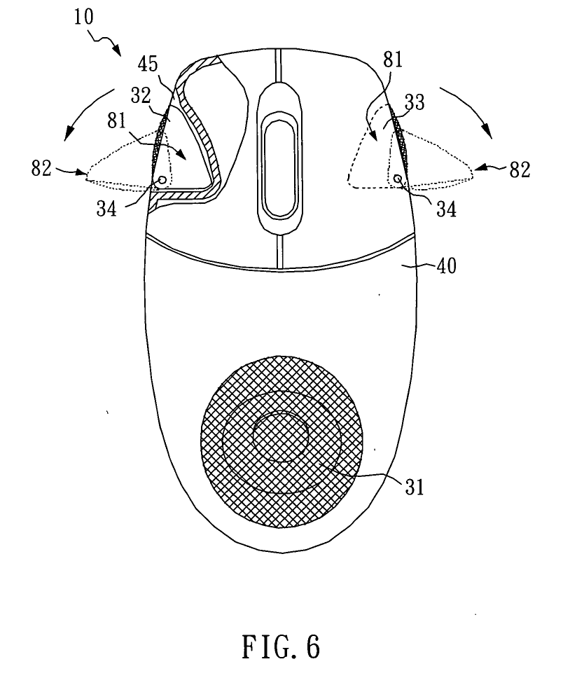

Please refer to FIG. 6 for a third embodiment of the present invention. The two tweeters 32, 33 are placed in front of the combined computer mouse and speaker device 10, but the two tweeters 32, 33 are pivoted onto the common housing 40 via a pivot mechanism 34, so that the two tweeters 32, 33 can be in either an opened state 82 or a closed state 81. In the opened state 82, the two tweeters 32, 33 are rotated towards the rear end of the mouse 10 so that the user is provided better audio quality. A concave 45 can be separately placed next to the two tweeters 32, 33, so the user can more easily pull out the two tweeters 32, 33. Many mechanisms may be used for opening the two tweeters 32, 33 such as by providing a spring and a catch (not shown) or other similar mechanisms as disclosed in U.S. Pat. No. 6,243,260.

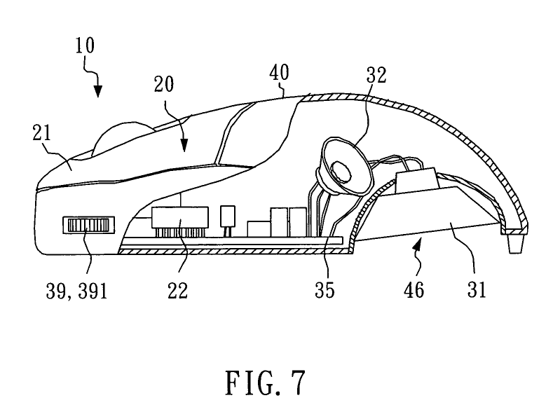

Please refer to FIG. 7. FIG. 7 is a cross-sectional schematic drawing of a fourth embodiment of the combined computer mouse and speaker device according to the present invention. The woofer/midrange speaker 31 is placed in the rear of the combined computer mouse and speaker device 10, and faces down. An opening 46 is placed at the bottom of the common housing 40 so that the audio from the woofer/midrange speaker 31 can be clearly heard.

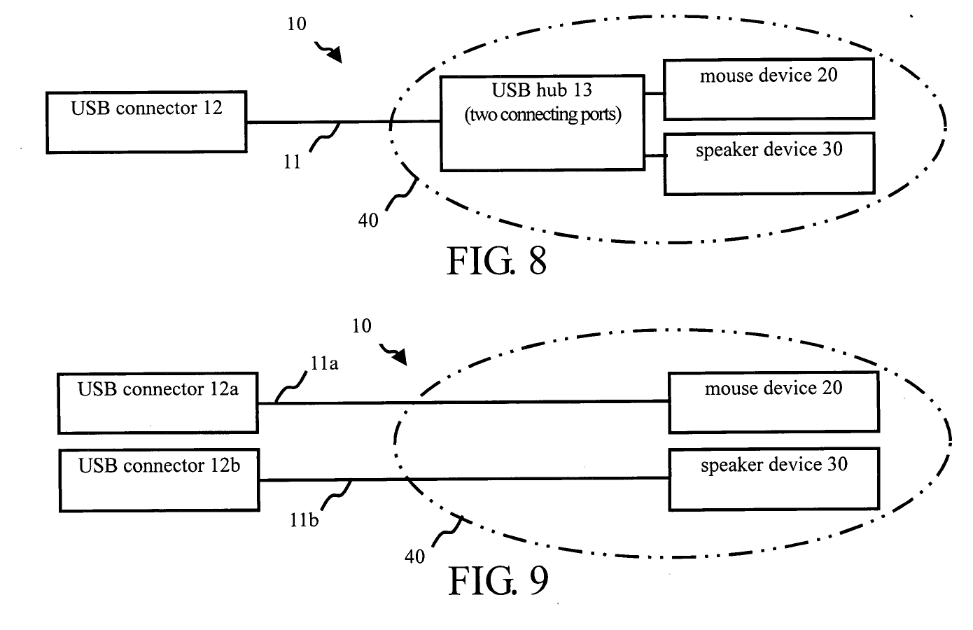

Please refer to FIG. 8. FIG. 8 is a block diagram of the circuit structure of the first to fourth embodiments. The control circuits of the mouse device 20 and the speaker device 30 are both connected to a USB hub 13 (two connecting ports); therefore, only one transmission cable 11 and one USB connector 12 are required. As the USB mouse is very common device, and as the USB standard supports audio devices, no further description is required.

Please refer to FIG. 9. The control circuits of the mouse device 20 and the speaker device 30 are separately connected to the transmission cables 11a, 11b and the USB connectors 12a, 12b, so that a USB hub is not required. Although, a defect has a more complicated cable layout, each device can obtain more power from the computer, and in particular the speakers.

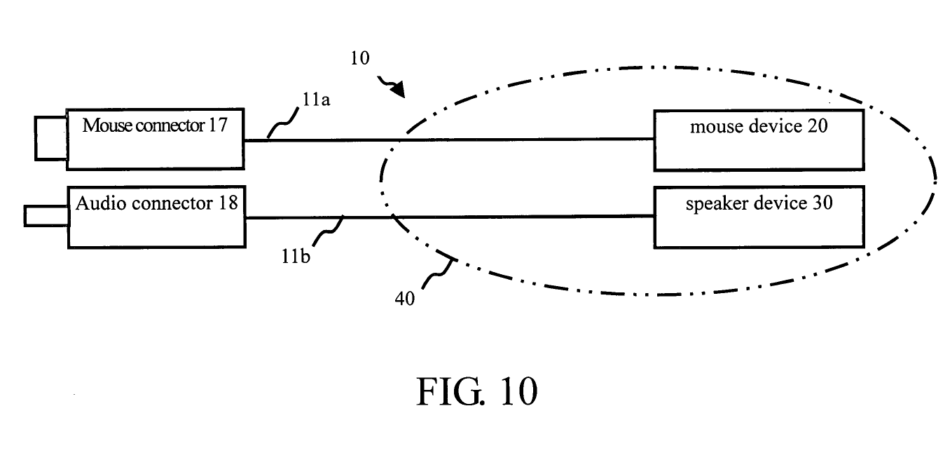

Please refer to FIG. 10. The mouse device 20 is connected to the computer via a mouse connector 17 (which is usually is a PS/2 connector or an RS232 connector). The speaker device 30 is connected to an audio card in the computer via a traditional audio connector 18.

FIG. 8 to FIG. 10 are used to illustrate particular examples of how the combined computer mouse and speaker device 10 may be connected to the computer. However, many other methods are available, such as wireless transmission protocols (like the Bluetooth technology).

Although the present invention has been explained in relation to its preferred embodiment, it is to be understood that many other possible modifications and variations can be made without departing from the spirit and scope of the invention as hereinafter claimed.

What is claimed is:

1. A combined computer mouse and speaker device electronically connected to a computer, the combined device comprising:
a mouse device;
a speaker device; and
a common housing for containing the mouse device and the speaker device;
wherein the combined computer mouse and speaker device is able to receive an audio signal sent from the computer and the combined computer mouse and speaker device utilizes the speaker device to play the audio signal.

2. The combined computer mouse and speaker device as claimed in claim 1 further comprising a speaker switch for controlling the speaker device.

3. The combined computer mouse and speaker device as claimed in claim 2, wherein the speaker switch further can control the volume of the speaker device.

4. The combined computer mouse and speaker device as claimed in claim 1 further comprising a volume adjustment switch for controlling the volume of the speaker device.

5. The combined computer mouse and speaker device as claimed in claim 1 further comprising at least one transmission cable capable of electronically connecting to the computer.

6. The combined computer mouse and speaker device as claimed in claim 5, wherein the at least one transmission cable receives power from the computer to provide the power to the speaker device.

7. The combined computer mouse and speaker device as claimed in claim 5 wherein the at least one transmission cable is a USB cable.

8. The combined computer mouse and speaker device as claimed in claim 1, wherein the speaker device comprises at least one woofer/midrange speaker.

9. The combined computer mouse and speaker device as claimed in claim 1, wherein the speaker device comprises at least one woofer/midrange speaker and two tweeters.

10. The combined computer mouse and speaker device as claimed in claim 9, wherein the two tweeters are pivoted onto the common housing so that the two tweeters can be rotated.
